(19) United States
(12) Patent Application Publication
(10) Pub. No.: US 2021/0167676 A1
(43) Pub. Date: Jun. 3, 2021

(54) AXIAL GAP MOTOR

(71) Applicant: SEIKO EPSON CORPORATION, Tokyo (JP)

(72) Inventor: Hiroshi KOEDA, SUWA-SHI (JP)

(21) Appl. No.: 17/105,619

(22) Filed: Nov. 26, 2020

(30) Foreign Application Priority Data
Nov. 28, 2019 (JP) 2019-215078

(51) Int. Cl. H02K 21/24; H02K 1/27; H02K 1/02

(52) U.S. Cl. CPC H02K 21/24; H02K 1/02; H02K 1/2793

(57) ABSTRACT

An axial gap motor includes a shaft extending along a rotation axis, a rotor including a hub, an annular rim, a coupling section coupling the hub and the rim, and a magnet held by the rim, the rotor rotating around the rotation axis together with the shaft, and a stator disposed to be separated from the rotor with a gap in an axial direction parallel to the rotation axis. A reinforcing member is provided in the coupling section.

The present application is based on, and claims priority from JP Application Serial Number 2019-215078, filed Nov. 28, 2019, the disclosure of which is hereby incorporated by reference herein in its entirety.

### BACKGROUND

### 1. Technical Field

The present disclosure relates to an axial gap motor.

### 2. Related Art

An axial gap motor described in JP-A-2009-296701 (Patent Literature 1) includes a rotor provided to be rotatable around a rotation axis and stators disposed to be opposed to hold the rotor therebetween. The rotor includes a rotor support and a magnet. The rotor support includes an annular rim section and a shaft section, a magnet held between the rim section and the shaft section, and an annular disc-like connecting section extending from the shaft section to the rotation axis side. The connecting section connects, for example, a driving shaft such as an input shaft of a transmission of a vehicle and an intermediate portion of a rib or the like.

In the rotor support described in Patent Literature 1, the shaft section, which holds the magnet, and the driving shaft are connected by the connecting section. Therefore, when torque is applied to the rotor, a bending moment concentrates on the connecting section and deformation easily occurs in the connecting section. As a result, vibration, noise, and the like involved in the deformation of the connecting section occur.

### SUMMARY

An axial gap motor according to an application example of the present disclosure includes: a shaft extending along a rotation axis; a rotor including a hub, an annular rim, a coupling section coupling the hub and the rim, and a magnet held by the rim, the rotor rotating around the rotation axis together with the shaft; and a stator disposed to be separated from the rotor with a gap in an axial direction parallel to the rotation axis. A reinforcing member is provided in the coupling section.

### BRIEF DESCRIPTION OF THE DRAWINGS

FIG. 1 is a longitudinal sectional view showing a schematic configuration of an axial gap motor according to a first embodiment.

FIG. 2 is an exploded perspective view showing a rotor and a shaft shown in FIG. 1.

FIG. 3 is a plan view showing only a part of the rotor shown in FIG. 2.

FIG. 4 is a X1-X1 line sectional view of FIG. 3.

FIG. 5 is a sectional view showing a first modification of the rotor shown in FIG. 4.

FIG. 6 is a sectional view showing a second modification of the rotor shown in FIG. 4.

FIG. 7 is a sectional view showing a third modification of the rotor shown in FIG. 4.

FIG. 8 is a longitudinal sectional view showing a schematic configuration of an axial gap motor according to a second embodiment.

FIG. 9 is an exploded perspective view showing a rotor, which is a conventional example, and the shaft.

FIG. 10 is an exploded perspective view showing a rotor, which is a conventional example, and the shaft.

### DESCRIPTION OF EXEMPLARY EMBODIMENTS

An axial gap motor according to the present disclosure is explained in detail below based on embodiments shown in the accompanying drawings.

### 1. First Embodiment

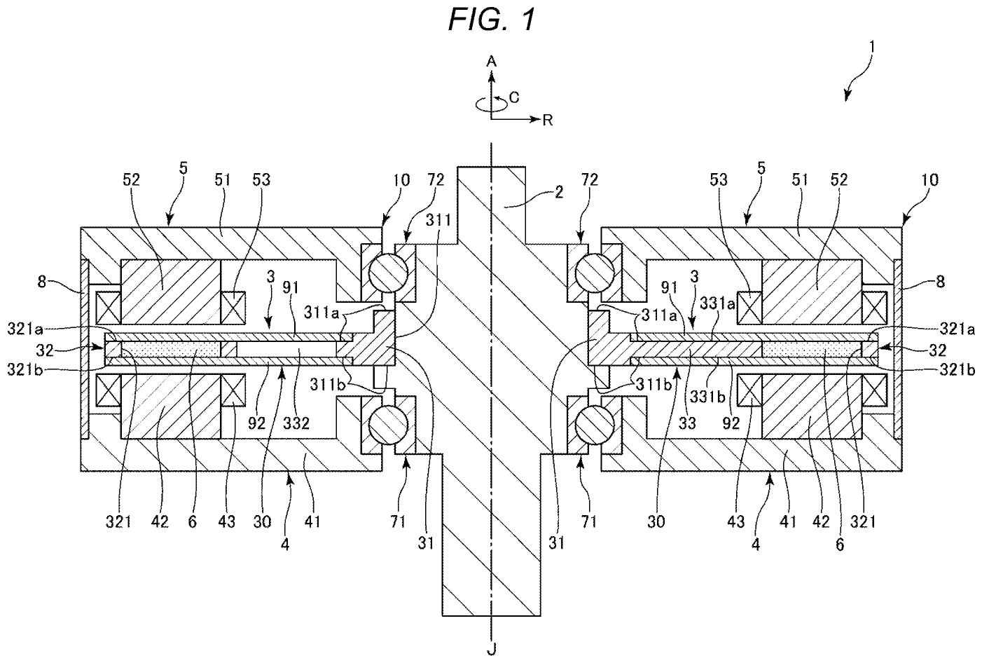

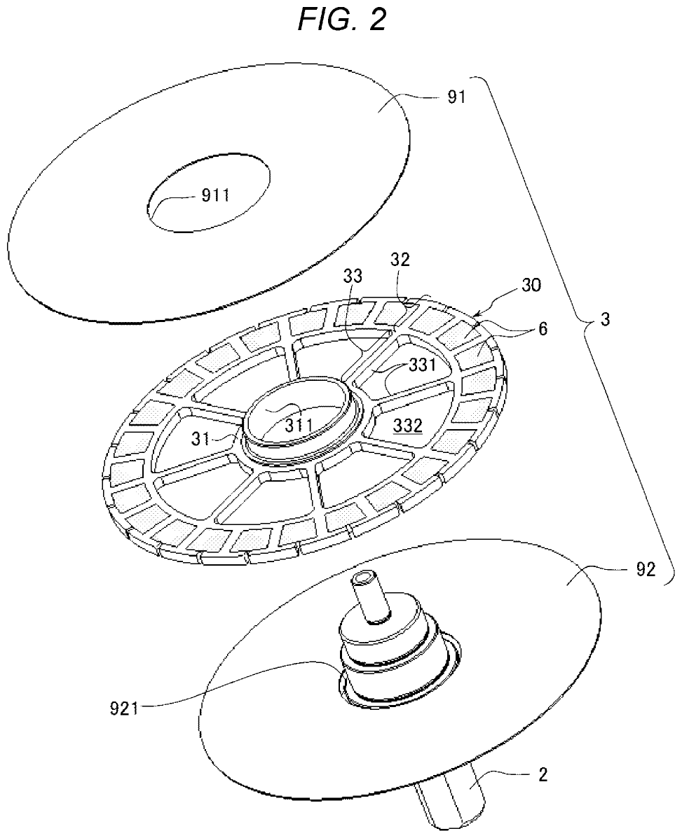

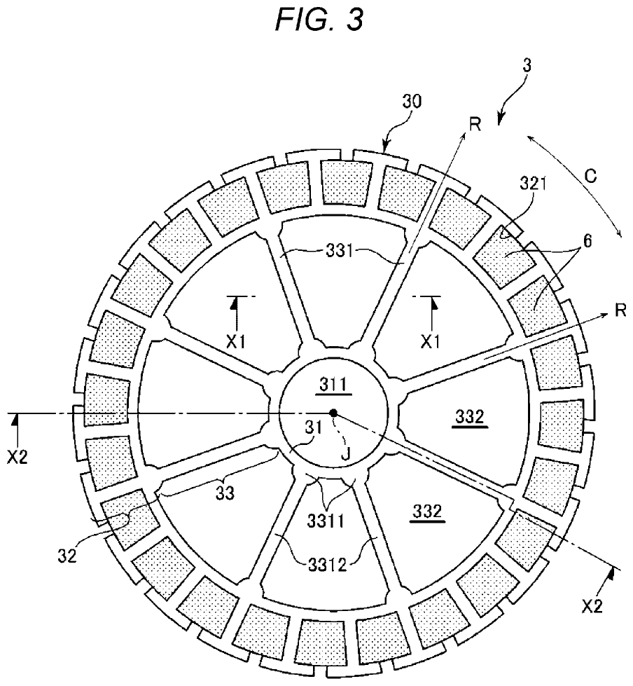

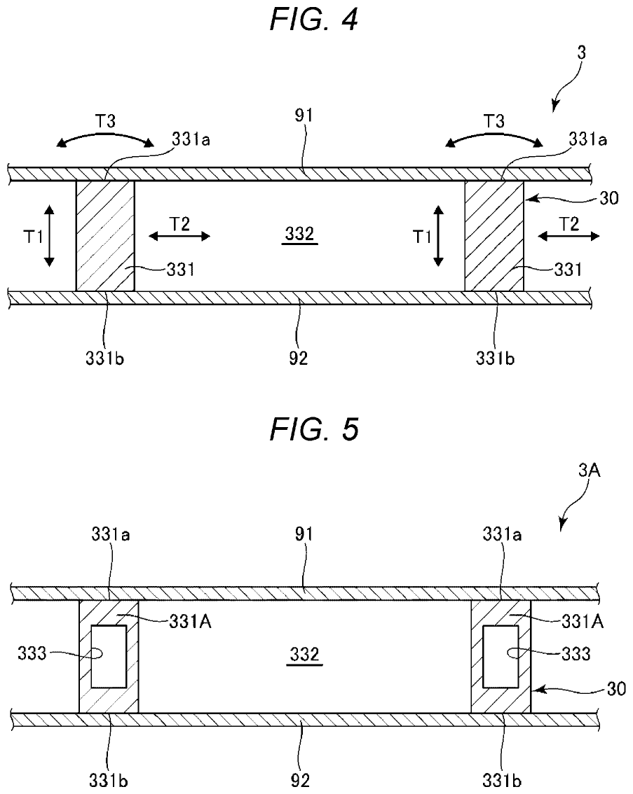

FIG. 1 is a longitudinal sectional view showing a schematic configuration of an axial gap motor according to a first embodiment. FIG. 2 is an exploded perspective view showing a rotor and a shaft shown in FIG. 1. FIG. 3 is a plan view showing only a part of the rotor shown in FIG. 2. FIG. 4 is a X1 -X1 line sectional view of FIG. 3. Note that FIG. 1 is a X2-X2 line sectional view of FIG. 3.

An axial gap motor 1 shown in FIG. 1 adopts a double stator structure including a shaft 2 that rotates around a rotation axis J, a rotor 3 that is fixed to the shaft 2 and rotates around the rotation axis J together with the shaft 2, and a pair of stators 4 and 5 disposed on both sides in an axial direction A of the rotor 3 along the rotation axis J. Such an axial gap motor 1 rotates the rotor 3 and the shaft 2 around the rotation axis J and transmits a rotational force to a driving target member coupled to the shaft 2. In this specification, for convenience of explanation, a direction along the rotation axis J is referred to as “axial direction A” as well, a direction orthogonal to the axial direction A is referred to as “radial direction R” as well, and the circumferential direction of the rotor 3 and the stators 4 and 5 is referred to as “circumferential direction C”. An arrow distal end side of the axial direction A is referred to as “upper” as well and the opposite side of the arrow distal end side is referred to as “lower” as well. Further, a plan view of viewing from above along the axial direction A is simply referred to as “plan view” as well. An arrow distal end side of the radial direction R is referred to as “outside” as well and an arrow proximal end side of the radial direction R is referred to as “center” as well.

The shaft 2 has a substantially columnar shape partially having a different outer diameter and is solid. Consequently, mechanical strength of the shaft 2 is improved. However, the shaft 2 may be hollow. In this case, a wire for the axial gap motor 1 can be inserted through the inside of the shaft 2.

The rotor 3 having a disc shape is fixed to the shaft 2 concentrically with the shaft 2. As shown in FIGS. 1 to 3, the rotor 3 includes a hub 31 located in the center of the rotor 3, an annular rim 32 located further on the outer side than the hub 31, and a coupling section 33 coupling the hub 31 and the rim 32. A plurality of permanent magnets 6 are held by the rim 32. The rotor 3 is explained in detail below.

The stators 4 and 5 are attached to the shaft 2 via bearings 71 and 72. The shaft 2 and the rotor 3 are rotatably supported with respect to a motor case 10 configured by combining the stators 4 and 5 using a side surface case 8. In this embodiment, a radial ball bearing is used as the bearings 71 and 72. However, the bearings 71 and 72 are not limited to the radial ball bearing. Various bearings such as an axial ball bearing, an angular ball bearing, and a taper roller bearing can be used.

As shown in FIG. 1, the stators 4 and 5 are disposed to hold the rotor 3 from above and below. Specifically, the stator 4 is disposed on the lower side of the rotor 3 via a gap and the stator 5 is disposed on the upper side of the rotor 3 via a gap. The stators 4 and 5 are disposed vertically symmetrically with respect to the rotor 3.

The stator 4 includes an annular back yoke 41 disposed concentrically with the shaft 2, a plurality of stator cores 42 supported on the upper surface of the back yoke 41 and disposed to be opposed to the permanent magnets 6, and a plurality of coils 43 disposed in the stator cores 42. Similarly, the stator 5 includes an annular back yoke 51 disposed concentrically with the shaft 2, a plurality of stator cores 52 supported on the lower surface of the back yoke 51 and disposed to be opposed to the permanent magnets 6, and a plurality of coils 53 disposed in the stator cores 52. The pluralities of stator cores 42 and 45 are disposed in the stators 4 and 5 in this way. Consequently, the shaft 2 rotates smoothly and the axial gap motor 1 has excellent driving efficiency.

The configuration of the stators 4 and 5 is explained in detail below. However, since the stators 4 and 5 have the same configuration, the stator 4 is representatively explained below. Explanation about the stator 5 is omitted.

The back yoke 41 is made of any one of various magnetic materials such as a stacked body of electromagnetic steel plates and a pressurized powder body of magnetic powder, in particular, a soft magnetic material. The back yoke 41 may be configured by an aggregate of a plurality of parts.

The stator cores 42 are disposed on the upper surface of the back yoke 41. The stator 4 includes a plurality of stator cores 42. The plurality of stator cores 42 are arranged side by side at equal intervals along the circumferential direction C. The stator corers 42 are made of any one of various magnetic materials such as a stacked body of electromagnetic steel plates and a pressurized powder body of magnetic powder, in particular, a soft magnetic material.

The stator cores 42 may be firmly fixed to the back yoke 41 by, for example, melting, an adhesive, or welding or may be engaged with the back yoke 41 by any one of various engaging means.

The coils 43 disposed on the stator cores 42 are wound on the outer circumferences of the stator cores 42. Electromagnets are configured by the stator cores 42 and the coils 43. The coils 43 may be individually wound on the stator cores 42 or may be wound up in a bobbin shape in advance and fit in the outer circumferences of the stator cores 42.

The axial gap motor 1 includes a not-shown energization circuit. The coils 43 are coupled to the energization circuit. The coils 43 are energized at a predetermined period or in a predetermined pattern. When the coils 43 are energized by, for example, a three-phase alternating current, magnetic fluxes are generated from the electromagnets and an electromagnetic force acts on the permanent magnets 6 opposed to the electromagnets. This state is periodically repeated, whereby the rotor 3 rotates around the rotation axis J.

The stator 4 is explained above. The entire stator 4 may be molded by resin. By molding the stator 4 with the resin in this way, it is possible to fix the back yoke 41 and the stator cores 42 to each other and obtain a more stable stator 4.

The configuration of the rotor 3 is explained in detail.

As explained above, the rotor 3 includes the rotor support 30 including the hub 31 located in the center of the rotor 3, the annular rim 32 located further on the outer side than the hub 31, and the coupling section 33 coupling the hub 31 and the rim 32.

As shown in FIG. 1, the hub 31 includes a through-hole 311 piercing through the hub 31 between an upper surface 311a and a lower surface 311b along the rotation axis J. The shaft 2 is fixed to the through-hole 311 by, for example, press fitting. Consequently, the shaft 2 and the rotor 3 are fixed. The length of the hub 31 along the rotation axis J, that is, the length in the axial direction A of the hub 31 is larger than the lengths in the axial direction A of the rim 32 and the coupling section 33. Consequently, a larger contact area of the hub 31 with the shaft 2 is secured to increase fixing strength. However, a fixing method for the shaft 2 and the rotor 3 is not particularly limited. The shape and the like of the hub 31 are not limited to the above.

As shown in FIG. 3, the rim 32 is formed in an annular shape having the center on the rotation axis J and includes a plurality of through-holes 321 provided at equal intervals along the circumferential direction C. The through-holes 321 pierce through the rim 32 between an upper surface 321a and a lower surface 321b along the rotation axis J. The permanent magnets 6 are respectively inserted into the through-holes 321. The number of the permanent magnets 6 is decided by the number of phases and the number of poles of the axial gap motor 1. For example, the number of the permanent magnets 6 is twenty-four in this embodiment. Examples of the permanent magnets 6 include a neodymium magnet, a ferrite magnet, a samarium-cobalt magnet, an alnico magnet, and a bond magnet. However, the permanent magnets 6 are not limited to these magnets.

As shown in FIG. 3, the coupling section 33 includes a plurality of beams 331 extending along the radial direction R. The plurality of beams 331 radially extend along the radial direction R centering on the rotation axis J and couple the hub 31 and the rim 32. That is, the coupling section 33 includes the plurality of beams 331 radially extending from the hub 31. Consequently, the plurality of beams 331 are disposed at equal intervals along the circumferential direction C. Voids 332 are formed among the beams 331. Since the coupling section 33 includes the beams 331 and the voids 332, it is possible to achieve a reduction in the weight of the rotor 3 without greatly spoiling the rigidity of the rotor 3.

An extension pattern of the beams 331 is not limited to the radial shape. For example, the beams 331 may cross one another to form a lattice shape or the beams 331 may form a honeycomb structure such that the plan view shape of the voids 332 is formed in a polygonal shape such as a hexagonal shape.

The plan view shape of the beams 331 is not particularly limited. In FIG. 3, the beams 331 are formed in a linear shape. The beams 331 include portions where the width of the beams 331 extending in the linear shape, that is, the length of the beams 331 in a direction of the beams 331 (the circumferential direction C) orthogonal to both of the rotation axis J and an axis (the radial direction R) on which the beams 331 extend gradually changes. Specifically, the beams 331 include a first portion 3311 and a second portion 3312, the widths of which are different from each other. The width of the first portion 3311 is large compared with the width of the second portion 3312. By providing the first portion 3311 in a coupling section to the hub 31 as shown in FIG. 3, such beams 331 is much less easily deformed even when stress concentrates on the coupling section. Consequently, it is possible to more surely suppress occurrence of vibration and noise in the rotor 3. By reducing the width of the second portion 3312 on which stress relatively less easily concentrates, it is possible to achieve a further reduction in the weight of the rotor 3. The plan view shape of the beams 331 is not limited to the linear shape and may be any shape.

As shown in FIGS. 1, 2, and 4, the rotor 3 includes a reinforcing member 91 provided on the upper side of the rotor support 30 and a reinforcing member 92 provided on the lower side of the rotor support 30.

The reinforcing members 91 and 92 are respectively plate-like members, plan view shapes of which are formed in annular shapes. The reinforcing member 91 is provided in contact with the upper surface 321a of the rim 32 and an upper surface 331a of the coupling section 33. The reinforcing member 92 is provided in contact with the lower surface 321b of the rim 32 and a lower surface 331b of the coupling section 33. Consequently, the rotor support 30 is held between the two reinforcing members 91 and 92.

By providing such reinforcing members 91 and 92, the rotor support 30 is reinforced to suppress bending deformation and torsional deformation from occurring. Examples of the bending deformation include bending deformation along the axial direction A indicated by an arrow T1 in FIG. 4 and bending deformation along the circumferential direction C indicated by an arrow T2 in FIG. 4. Examples of the torsional deformation include torsional deformation around an axis extending in the radial direction R indicated by an arrow T3 in FIG. 4. By providing the reinforcing members 91 and 92, it is possible to suppress these kinds of deformation.

A constituent material of the reinforcing members 91 and 92 is not particularly limited. However, a material having a Young's modulus higher than the Young's modulus of a constituent material of the rotor support 30 is preferably used. By using such a material, it is possible to, while achieving a reduction in the weight of the rotor 3, suppress deterioration in mechanical strength involved in the reduction in the weight. As a result, it is possible to realize the rotor 3 that achieves both of a reduction in weight and low deformability.

In the axial gap motor 1, large torque is caused by an interaction of the permanent magnets 6 and the stators 4 and 5. The torque sometimes periodically fluctuates. In that case, vibration occurs in the rotor 3 and noise also occurs according to the occurrence of the vibration. On the other hand, by providing the reinforcing members 91 and 92, it is possible to suppress deformation of the rotor support 30. Since the deformation of the rotor support 30 is suppressed, it is possible to suppress vibration and noise that occur during the rotation of the rotor 3.

Examples of a constituent material of the rotor support 30 include metal materials such as stainless steel, an aluminum alloy, a magnesium alloy, and a titanium alloy. The constituent material of the rotor support 30 is preferably a nonmagnetic material. Consequently, the rotor support 30 less easily affects magnetic fluxes formed by the permanent magnets 6 and the coils 43. Problems such as a decrease in torque less easily occur. Examples of the nonmagnetic material include austenitic stainless steel.

The reinforcing member 91 includes a through-hole 911 in the center thereof and the reinforcing member 92 includes a through-hole 921 in the center thereof. The hub 31 of the rotor support 30 is inserted into each of the through-holes 911 and 921.

Examples of a constituent material of the reinforcing members 91 and 92 include a metal material, a ceramics material, a carbon fiber, a glass fiber, and a resin material and include a composite material of one or two or more kinds of these materials.

The reinforcing members 91 and 92 preferably include an electromagnetic steel plate. Since the electromagnetic steel plate has a relatively high Young's modulus, even when the rigidity of the rotor support 30 is low, the reinforcing members 91 and 92 give rigidity to the rotor support 30. Consequently, it is possible to particularly suppress deformation of the rotor support 30. Further, since the electromagnetic steel plate is a soft magnetic material, fluctuation in torque, in particular, cogging torque due to alternate side-by-side arrangement of an N-pole magnet and an S-pole magnet along the circumferential direction C is reduced. Occurrence of vibration of the rotor 3 and noise involved in the vibration is suppressed.

The reinforcing members 91 and 92 may include a magnetic material other than the electromagnetic steel plate. In this case, the same effects as the effects explained above are obtained. Examples of the magnetic material other than the electromagnetic steel plate include soft magnetic materials such as an amorphous metal, Permalloy, Sendust, Permendure, and pure iron.

An average thickness of the reinforcing members 91 and 92 is not particularly limited. However, the average thickness of the reinforcing members 91 and 92 is preferably 0.10 mm or more and 1.50 mm or less and more preferably 0.20 mm or more and 1.00 mm or less. Such reinforcing members 91 and 92 give a sufficient reinforcing effect to the rotor support 30 while suppressing the thickness of the rotor 3 from increasing. Therefore, it is possible to realize the rotor 3 with less vibration and noise while avoiding an increase in the weight and an increase in the size of the rotor 3.

The reinforcing members 91 and 92 may be fixed to the rotor support 30 by any method. Examples of the fixing method include an adhesive, joining metal, and welding. However, the adhesive is preferably used. By using the adhesive, not only the rotor support 30 and the reinforcing members 91 and 92 but also the permanent magnets 6 and the reinforcing members 91 and 92 can be bonded. As a result, the rotor 3 can be integrated by the reinforcing members 91 and 92. Deformation of the rotor 3 can be particularly reduced.

The length of the permanent magnets 6 along the rotation axis J, that is, the thickness of the permanent magnets 6 is substantially equal to the length of the through-holes 321 along the rotation axis J, that is, the thickness of the through-holes 321. The plan view shape of the permanent magnets 6 is substantially equal to the plan view shape of the through-holes 321. Consequently, the permanent magnets 6 fill the through-holes 321 almost without gaps. Since the upper surfaces of the permanent magnets 6 can be aligned with the upper surface 321a of the rim 32, it is possible to bond the reinforcing member 91 to both of the rim 32 and the permanent magnets 6. Similarly, since the lower surfaces of the permanent magnets 6 can be aligned with the lower surface 321b of the rim 32, it is possible to bond the reinforcing member 92 to both of the rim 32 and the permanent magnets 6. As a result, it is possible to particularly integrate the rotor 3.

The reinforcing member 91 is in contact with the upper surface 331a (a first surface) of the coupling section 33. Similarly, the reinforcing member 92 is in contact with the lower surface 331b (a second surface) of the coupling section 33. That is, the reinforcing members 91 and 92 are provided on both of the upper surface 331a facing one end side (the upper end side) of the rotation axis J and the lower surface 331b facing the other end side (the lower end side) of the rotation axis J of the coupling section 33. Consequently, it is possible to suppress deformation of the coupling section 33 including the beams 331, which are easily deformed, and suppress occurrence of vibration and noise. When the coupling section 33 includes the beams 331, a windage loss easily occurs according to the rotation of the rotor 3. However, covering the coupling section 33 with the reinforcing members 91 and 92 contributes to a reduction in such a windage loss. In this specification, “in contact” indicates a state of direct contact or indirect contact via an interposed object such as an adhesive.

The reinforcing members 91 and 92 are respectively formed in the plate shapes as explained above and couple the beams 331. Consequently, the beams 331 can be integrated. Therefore, the coupling section 33 can be sufficiently reinforced even in a state in which the voids 332 are provided among the beams 331. As a result, it is possible to achieve both of a reduction in weight and low deformability.

As explained above, the coupling section 33 includes the voids 332 located among the beams 331. Since the coupling section 33 includes the beams 331 and the voids 332, it is possible to achieve a reduction in the weight of the rotor 3.

The voids 332 may be substituted by bottomed recesses. In that case, the recesses may be opened in the upper surface 331a or may be opened in the lower surface 331 b. In that case as well, it is possible to achieve a reduction in the weight of the rotor 3.

A filler may be stored in at least a part of the voids 332 according to necessity. Examples of the filler include an adhesive, a resin mold material, a resin foam, and a foaming material. By providing the filler, it is possible to further reinforce the rotor 3 and improve low deformability without greatly spoiling a reduction in weight.

The reinforcing members 91 and 92 shown in FIGS. 1 and 2 are provided not only in the coupling section 33 but also in the rim 32. That is, the reinforcing members 91 and 92 are provided from the coupling section 33 to the rim 32. Specifically, the reinforcing member 91 is in contact with the upper surface 321a of the rim 32. Similarly, the reinforcing member 92 is in contact with the lower surface 321b of the rim 32. Consequently, the rim 32, which is easily deformed by a magnetic force, can be more firmly reinforced. As a result, it is possible to suppress occurrence of vibration and noise of the rotor 3 involved in deformation of the coupling section 33 and the rim 32. In this embodiment, as explained above, the reinforcing members 91 and 92 are in contact with not only the rim 32 but also the permanent magnets 6. Consequently, it is possible to particularly reduce the deformation of the rim 32.

In this case, the reinforcing member 91 is provided between the permanent magnets 6 and the stator 5. Similarly, the reinforcing member 92 is provided between the permanent magnets 6 and the stator 4. In such disposition of the reinforcing members 91 and 92, when the reinforcing members 91 and 92 are magnetic bodies, it is possible to reduce cogging torque and suppress occurrence of vibration and noise in the rotor 3.

Further, the reinforcing members 91 and 92 shown in FIGS. 1 and 2 are provided in the hub 31 as well. Specifically, the reinforcing member 91 is in contact with the upper surface 311a of the hub 31. Similarly, the reinforcing member 92 is in contact with the lower surface 311b of the hub 31. Consequently, the reinforcing members 91 and 92 are disposed to extend from the hub 31 to the rim 32 through the coupling section 33. As a result, it is possible to integrate substantially the entire rotor 3 and particularly reduce deformation of the rotor 3.

As explained above, the axial gap motor 1 according to this embodiment includes the shaft 2, the rotor 3, and the stators 4 and 5. The shaft 2 extends along the rotation axis J. The rotor 3 includes the hub 31, the annular rim 32, the coupling section 33 coupling the hub 31 and the rim 32, and the permanent magnets 6 held by the rim 32 and rotates around the rotation axis J together with the shaft 2. The stators 4 and 5 are respectively disposed to be separated from the rotor 3 with a gap in the axial direction A parallel to the rotation axis J. The reinforcing members 91 and 92 are provided in the coupling section 33 of the rotor 3.

In such an axial gap motor 1, by providing the reinforcing members 91 and 92, it is possible to suppress deformation of the coupling section 33. As a result, it is possible to suppress deformation of the rotor support 30. Since deformation of the rotor support 30 is suppressed, it is possible to suppress vibration and noise that occur during the rotation of the rotor 3.

### 2. First Modification

FIG. 5 is a sectional view showing a first modification of the rotor 3 shown in FIG. 4. In FIG. 5, a cross section of the same part as the part shown in FIG. 4 is shown.

In the rotor 3 shown in FIG. 4, a cross section of the beams 331 is solid. On the other hand, a cross section of beams 331A shown in FIG. 5 is hollow. That is, the beams 331A shown in FIG. 5 include, on the inside of the beams 331A, hollow sections 333 extending along the radial direction R and not exposed to side surfaces of the beams 331A. A reduction in the weight of such beams 331A can be achieved without greatly spoiling bending strength. As a result, it is possible to realize a rotor 3A further reduced in weight while suppressing occurrence of vibration and noise.

In the first modification explained above, the same effects as the effects in the first embodiment are obtained.

### 3. Second modification

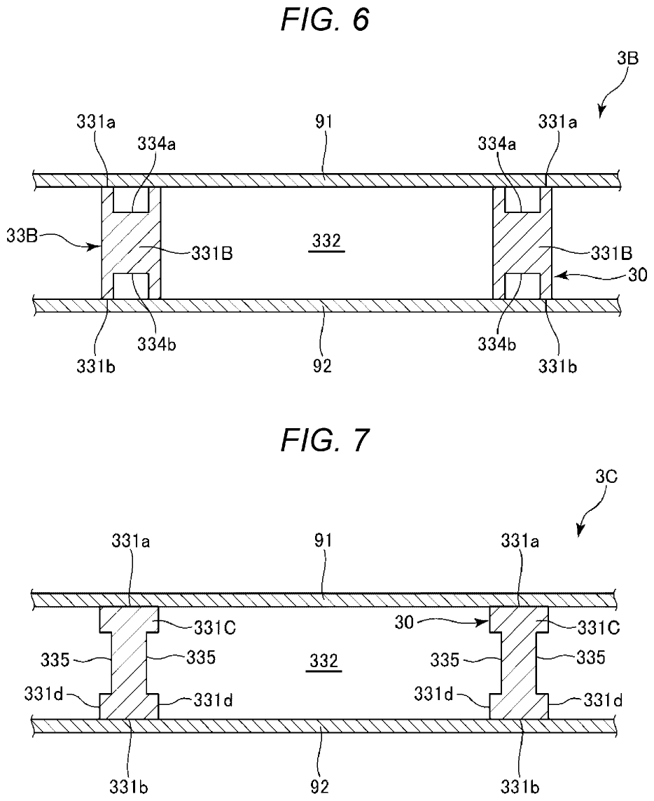

FIG. 6 is a sectional view showing a second modification of the rotor 3 shown in FIG. 4. In FIG. 6, a cross section of the same part as the part shown in FIG. 4 is shown.

In a rotor 3B shown in FIG. 6, beams 331 B of a coupling section 33B include recesses 335a opened in upper surfaces 331a of the beams 331 B and recesses 334b opened in lower surfaces 331b of the beams 331 B. A reduction in the weight of the beams 331 B can be achieved without greatly spoiling bending strength. As a result, it is possible to realize the rotor 3B further reduced in weight while suppressing occurrence of vibration and noise. One of the recesses 335a and 334b may be omitted.

In the second modification explained above, the same effects as the effects in the first embodiment are obtained.

### 4. Third Modification

FIG. 7 is a sectional view showing a third modification of the rotor 3 shown in FIG. 4. In FIG. 7, a cross section of the same part as the part shown in FIG. 4 is shown.

In a rotor 3C shown in FIG. 7, beams 331C include recesses 335 opened in side surfaces 331d of the beams 331C. A reduction in the weight of the beams 331C can be achieved without greatly spoiling bending strength. As a result, it is possible to realize the rotor 3C further reduced in weight while suppressing occurrence of vibration and noise.

In the third modification explained above, the same effects as the effects in the first embodiment are obtained.

### 5. Second Embodiment

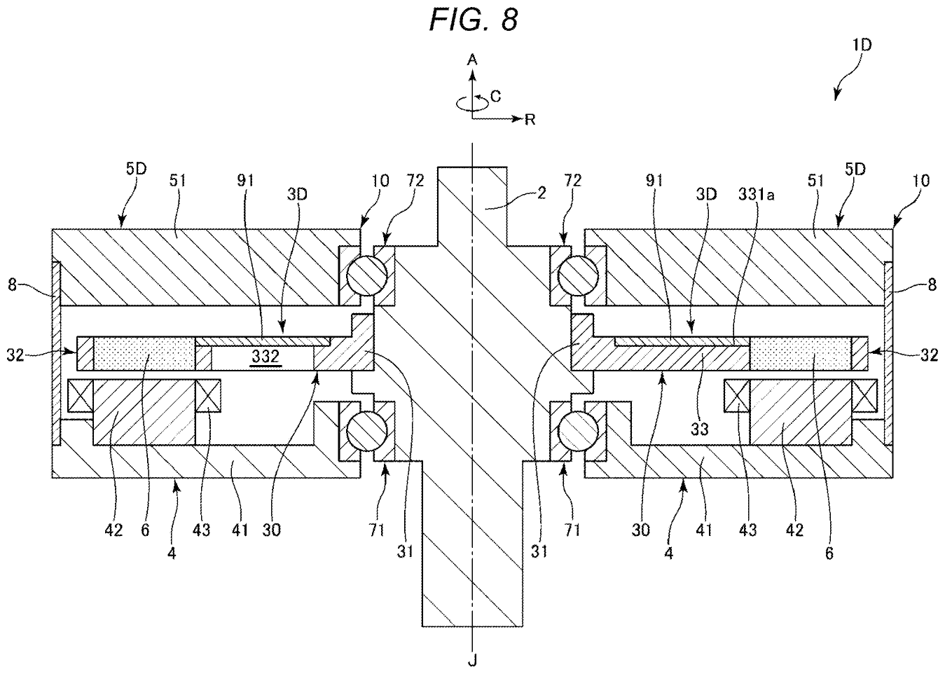

FIG. 8 is a longitudinal sectional view showing a schematic configuration of an axial gap motor according to a second embodiment.

The second embodiment is explained below. In the following explanation, differences from the first embodiment are mainly explained. Explanation about similarities to the first embodiment is omitted. In FIG. 8, the same components as the components in the first embodiment are denoted by the same reference numerals and signs.

The second embodiment is the same as the first embodiment except that the configurations of the rotor 3 and the stator 5 are different.

The stator 5 according to the first embodiment explained above includes the stator cores 52 and the coils 53. On the other hand, in a stator 5D according to this embodiment, the stator cores 52 and the coils 53 are omitted. Therefore, an axial gap motor 1D according to this embodiment has a single stator structure.

In the rotor 3 according to the first embodiment explained above, the reinforcing members 91 and 92 are provided to hold the rotor support 30 from above and below. On the other hand, in a rotor 3D according to this embodiment, the reinforcing member 92 is omitted. In this way, in this embodiment, by omitting one of the reinforcing members 91 and 92, a reduction in the weight of the rotor 3D can be achieve. The stator cores 42 and the coils 43 are provided in the stator 4 according to this embodiment. However, by providing the reinforcing member 91 located on the surface on the opposite side of the stator cores 42 and the coils 43 in the rotor support 30, that is, the upper surface of the rotor support 30, in other words, by omitting only the reinforcing member 92, it is possible to sufficiently reinforce the rotor 3D while achieving a reduction in the weight of the rotor 3D.

Such an effect is obtained because of a reason explained below. Since the stator cores 42 and the coils 43 attract the permanent magnets 6 of the rotor 3D with a magnetic force, the rotor support 30 is easily bent downward in FIG. 8. On the other hand, by providing the reinforcing member 91 on the upper surface of the rotor support 30, tension of pulling in a surface of the reinforcing member 91 is applied to the reinforcing member 91. The reinforcing member 91 has sufficient yield strength against the tension. Accordingly, it is possible to sufficiently suppress deformation of the rotor support 30.

Therefore, based on both of the first embodiment and this embodiment, the reinforcing members 91 and 92 are provided on at least one of the upper surface 331a (the first surface) facing one end side of the rotation axis J and the lower surface 331b (the second surface) facing the other end side of the rotation axis J of the coupling section 33. Consequently, deformation of the coupling section 33 including the beams 331, which are easily deformed, is suppressed and occurrence of vibration and noise is suppressed.

In the rotor 3D according to this embodiment, the outer diameter of the reinforcing member 91 is reduced. The reinforcing member 91 is provided further on the shaft 2 side than the permanent magnets 6. Consequently, the area of the reinforcing member 91 can be reduced and a reduction in weight and a reduction in cost can be achieved. The permanent magnets 6 themselves have sufficient rigidity and function as reinforcing bodies that suppress deformation of the rotor support 30. Accordingly, even if the permanent magnets 6 are not covered by the reinforcing member 91, it is possible to sufficiently suppress deformation of the rotor 3D.

The size of the reinforcing member 91 is not limited to the size described above and may be size for covering all or a part of the permanent magnets 6. The reinforcing member 92 may be provided without being omitted. In that case as well, the reinforcing member 92 may be provided to avoid the permanent magnets 6 or may be provided to cover the permanent magnets 6.

In the second embodiment explained above, the same effects as the effects in the first embodiment are obtained.

### 6. Structure Analysis

In order to evaluate a difference in a deformation amount due to a difference in the configuration of a rotor, a simulation result by a structure analysis is explained.

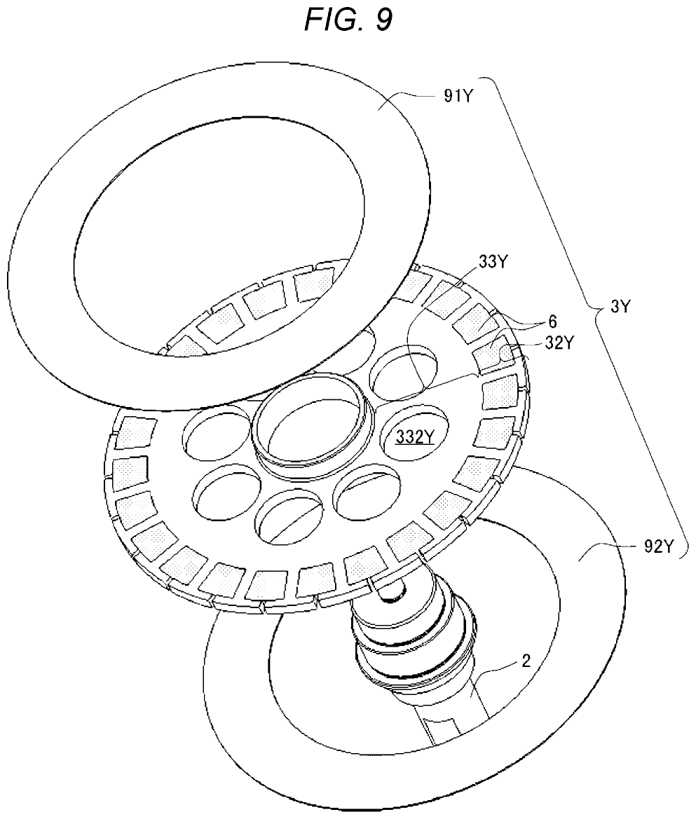

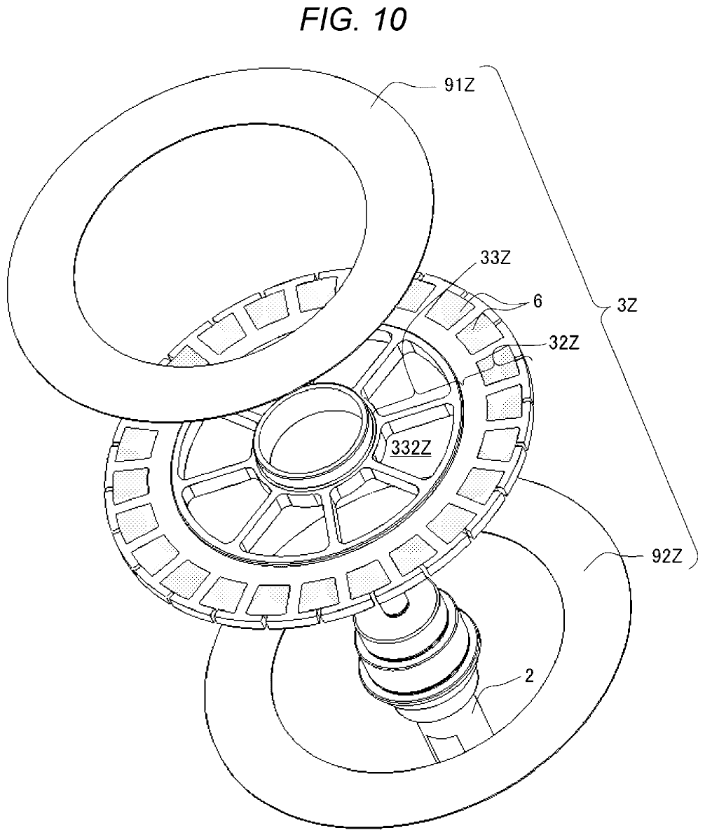

In a simulation, about the rotor 3 shown in FIG. 2, a rotor 3Y shown in FIG. 9, and a rotor 3Z shown in FIG. 10, displacement amounts at the time when a translational force and a rotational force (torque) were applied were compared. The simulation result is shown in Table 1 below.

FIG. 9 is an exploded perspective view showing the rotor 3Y, which is a conventional example, and the shaft 2. FIG. 10 is an exploded perspective view showing the rotor 3Z, which is the conventional example, and the shaft 2.

In the rotor 3Y shown in FIG. 9, the plan view shape of voids 332Y included in a coupling section 33Y is different from the plan view shape of the voids 332 included in the coupling section 33 of the rotor 3 shown in FIG. 2. Reinforcing members 91Y and 92Y shown in FIG. 9 are respectively provided in only a rim 32Y of the rotor 3Y.

In the rotor 3Z shown in FIG. 10, the plan view shape of voids 332Z included in a coupling section 33Z is the same as the plan view shape of the voids 332 included in the coupling section 33 of the rotor 3 shown in FIG. 2. On the other hand, the thickness of the coupling section 33Z is larger than the thickness of the coupling section 33 of the rotor 3 shown in FIG. 2.

Reinforcing members 91Z and 92Z shown in FIG. 10 are respectively provided in only a rim 32Z of the rotor 3Z.

“Weight” in Table 1 indicates the weights of the rotors 3, 3Y, and 3Z. “Displacement amount (1)” in Table 1 indicates a displacement amount along the axial direction A of the permanent magnets 6 at the time when a translational force of 100 N is applied to the entire permanent magnets 6 along the axial direction A. Further, “displacement amount (2)” in Table 1 indicates a displacement amount along the circumferential direction C of the permanent magnets 6 at the time when a rotational force of 6 N·m is applied to the entire permanent magnets 6 along the circumferential direction C.

TABLE 1

| | | | | Simulation result | | |
|---|---|---|---|---|---|---|
| | | | | Displacement | Displacement | |
| | | | | amount (1) at | amount (2) at | |
| | | | | the time when | the time when a | |
| Structure condition | | | | a translational | rotational force is | |
| FIG. | Difference | | | force is applied | applied along the | |
| showing | in structure | | | along the axial | circumferential | |
| structure | from FIG. 2 | Weight | | direction A | direction C | |
| FIG. 2 | — | 93.0 | g | 16 μm | 2.5 | μm |
| (embodiment) | | | | | | |
| FIG. 9 | The reinforcing | 118.0 | g | 18 μm | 19.0 | μm |
| (comparative | members 91Y and | | | | | |
| example) | 92Y are provided in | | | | | |
| | only the rim 32Y | | | | | |
| FIG. 10 | 1: The reinforcing | 108.5 | g | 19 μm | 48.0 | μm |
| (Comparative | members 91Z and | | | | | |
| example) | 92Z are provided in | | | | | |
| | only the rim 32Z | | | | | |
| | 2: The thickness of | | | | | |
| | the coupling section | | | | | |
| | 33Z is large | | | | | |

As shown in Table 1, a reduction in the weight of the rotor 3 shown in FIG. 2 equivalent to the embodiment is achieved compared with the rotor 3Y shown in FIG. 9 and the rotor 3Z shown in FIG. 10 equivalent to the comparative example.

On the other hand, as a result of the simulation, the displacement amount (1) of the rotor 3 is sufficiently reduced compared with the displacement amount (1) of the rotor 3Y heavier than the rotor 3 and the displacement amount (1) of the rotor 3Z heavier than the rotor 3. The displacement amount (2) of the rotor 3 is also reduced compared with the replacement amount (2) of the rotor 3Y and the displacement amount (2) of the rotor 3Z.

From this result, it has been made clear that, by providing the reinforcing members 91 and 92 in the coupling section 33, it is possible to sufficiently reduce the displacement amount (1) and the displacement amount (2) while achieving a reduction in weight.

In particular, in the rotor 3Y shown in FIG. 9, since an area ratio of the voids 332Y in the coupling section 33Y is small, it is expected that the coupling section 33Y alone has higher rigidity than the rigidity of the coupling section 33 shown in FIG. 2. However, it has been recognized that the coupling section 33 is sufficiently benefited by the reinforcing action by the reinforcing members 91 and 92, whereby the rotor 3 shown in FIG. 2 has rigidity equal to or larger than the rigidity of the rotor 3Y.

Similarly, in the rotor 3Z shown in FIG. 10, since the thickness of the coupling section 33Z is large, it is expected that the coupling section 33Z alone has rigidity higher than the rigidity of the coupling section 33 shown in FIG. 2. However, it has been recognized that the coupling section 33 is sufficiently benefited by the reinforcing action by the reinforcing members 91 and 92, whereby the rotor 3 shown in FIG. 2 has rigidity equal to or larger than the rigidity of the rotor 3Z.

Therefore, it has been recognized that it is effective to provide the reinforcing members 91 and 92 at least in the coupling section 33. As long as the reinforcing members 91 and 92 are provided in the coupling section 33, circular voids 332Y in the coupling section 33Y may be provided in the coupling section 33 or the coupling section 33 may be formed in a thicker shape than the rim 32Z in the coupling section 33Z.

Although not shown in Table 1, about the rotor 3D shown in FIG. 8 as well, it has been recognized that the displacement amount (1) and the displacement amount (2) can be reduced compared with the comparative example.

The axial gap motor according to the present disclosure is explained above based on the illustrated embodiments. However, the present disclosure is not limited to this. The components of the sections can be replaced with any components having the same functions. Any other components may be added to the present disclosure. The modifications and the embodiments explained above may be combined as appropriate. It is also possible to adopt a form in which a shaft is fixed, disposition of a rotor and stators is reversed, and the rotor rotates around the shaft.

What is claimed is:

1. An axial gap motor comprising:
a shaft extending along a rotation axis;
a rotor including a hub, an annular rim, a coupling section coupling the hub and the rim, and a magnet held by the rim, the rotor rotating around the rotation axis together with the shaft; and
a stator disposed to be separated from the rotor with a gap in an axial direction parallel to the rotation axis, wherein a reinforcing member is provided in the coupling section.

2. The axial gap motor according to claim 1, wherein the reinforcing member is provided from the coupling section to the rim.

3. The axial gap motor according to claim 1, wherein the reinforcing member is provided between the magnet and the stator.

4. The axial gap motor according to claim 1, wherein the reinforcing member is provided from the coupling section to a position closer to the shaft than the magnet.

5. The axial gap motor according to claim 1, wherein the reinforcing member includes an electromagnetic steel plate.

6. The axial gap motor according to claim 1, wherein the reinforcing member is provided on at least one of a first surface facing one end side of the rotation axis and a second surface facing another end side of the rotation axis of the coupling section.

7. The axial gap motor according to claim 6, wherein the coupling section includes a recess opened in the first surface or the second surface.

8. The axial gap motor according to claim 1, wherein the coupling section includes a plurality of beams radially extending from the hub.

9. The axial gap motor according to claim 8, wherein the reinforcing member is formed in a plate shape and couples the beams.

10. The axial gap motor according to claim 8, wherein the coupling section includes a first portion and a second portion, lengths of which in a direction orthogonal to both of the rotation axis and an axis on which the beams extends are different from each other.
